(19) United States
(12) Patent Application Publication
(10) Pub. No.: US 2024/0330016 A1
(43) Pub. Date: Oct. 3, 2024

(54) CLASS FILE PROCESSING METHOD AND APPARATUS, DEVICE, MEDIUM, AND PRODUCT

(71) Applicant: Beijing Zitiao Network Technology Co., Ltd., Beijing (CN)

(72) Inventor: Yongkang Dong, Beijing (CN)

(21) Appl. No.: 18/622,401

(22) Filed: Mar. 29, 2024

(30) Foreign Application Priority Data
Mar. 31, 2023 (CN) 202310343395.4

(51) Int. Cl. G06F 9/445; G06F 9/448; G06F 40/205

(52) U.S. Cl. CPC G06F 9/44521; G06F 9/4488; G06F 40/205

(57) ABSTRACT

Embodiments of the present disclosure disclose a class file processing method and apparatus, a device, a medium, and a product. The method includes: obtaining respective anonymous inner class files generated after performing class file merging and compiling on respective class files in an AAR file of a target application program, and parsing file name identifying information of the respective anonymous inner class files; determining associated code resource bundles of the respective corresponding anonymous inner class files based on parsing results of the file name identifying information; and in response to that the associated code resource bundle of one anonymous inner class file is inconsistent with a code resource bundle where the one anonymous inner class file is currently located, dispatching the one anonymous inner class file into the corresponding associated code resource bundle.

### CROSS-REFERENCE TO RELATED APPLICATION(S)

This application claims priority to Chinese Application No. 202310343395.4 filed on Mar. 31, 2023, the disclosure of which is incorporated herein by reference in its entirety.

### FIELD

Embodiments of the present disclosure relate to the technical field of application program development, and in particular, to a class file processing method and apparatus, a device, a medium, and a product.

### BACKGROUND

In a process of bundling an application program into a posting format of Android App Bundle (AAB), it is common to perform class merging on a class file of a basic resource module and a class file of an adaptive function module in an Android Archive (AAR) file of the application program to obtain a corresponding Jar bundle. However, after the class merging is performed, a dex compiler (D8) will be used to perform desugaring to generate some anonymous inner classes, and the anonymous inner classes are uniformly bundled into a base code resource bundle. As a result, the base code resource bundle may contain some unnecessary code files bundled into the base code resource bundle, and the class files are not correctly sub-bundled.

### SUMMARY

The present disclosure provides a class file processing method and apparatus, a device, a medium, and a product, which can sub-bundle anonymous inner classes generated after desugaring to enable the anonymous inner classes to be correctly dispatched into corresponding resource bundles, so as to optimize a base code resource bundle of an application program.

In a first aspect, the embodiments of the present disclosure provide a class file processing method. The method includes:

obtaining respective anonymous inner class files generated after performing class file merging and compiling on respective class files in an Android Archive (AAR) file of a target application program, and parsing file name identifying information of the respective anonymous inner class files;

determining associated code resource bundles of the respective corresponding anonymous inner class files based on parsing results of the file name identifying information; and

in response to that the associated code resource bundle of one anonymous inner class file is inconsistent with a code resource bundle where the one anonymous inner class file is currently located, dispatching the one anonymous inner class file into the corresponding associated code resource bundle.

In a second aspect, the embodiments of the present disclosure provide a class file processing apparatus. The apparatus includes:

a target class file searching module, configured to: obtain respective anonymous inner class files generated after performing class file merging and compiling on respective class files in an AAR file of a target application program, and parse file name identifying information of the respective anonymous inner class files;

a target class file analysis module, configured to determine associated code resource bundles of the respective corresponding anonymous inner class files based on parsing results of the respective file name identifying information; and

a target class file processing module, configured to: in response to that the associated code resource bundle of one anonymous inner class file is inconsistent with a code resource bundle where the one anonymous inner class file is currently located, dispatch the one anonymous inner class file into the corresponding associated code resource bundle.

In a third aspect, the embodiments of the present disclosure provide an electronic device. The electronic device includes:

one or more processors;

a storage for storing one or more programs which, when executed by the one or more processors, cause the one or more processors to implement the class file processing method described in any of the embodiments of the present disclosure.

In a fourth aspect, the embodiments of the present disclosure further provide a storage medium including computer-executable instructions. The computer-executable instructions, when executed by a computer processor, are used for performing the class file processing method described in any of the embodiments of the present disclosure.

In a fifth aspect, the embodiments of the present disclosure provide a computer program product, including a computer program, and the computer program, when executed by a processor, implements the class file processing method described in any of the embodiments of the present disclosure.

In the embodiments of the present disclosure, in a process of generating an application program bundle with an AAB format, respective anonymous inner class files generated after performing class file merging and compiling on respective class files in an AAR file of a target application program are sub-bundled; file name identifying information of the respective anonymous inner class files are first parsed; associated code resource bundles of the respective corresponding anonymous inner class files are determined based on parsing results of the file name identifying information; and in response to that the associated code resource bundle of one anonymous inner class file is inconsistent with a code resource bundle where the one anonymous inner class file is currently located, the one anonymous inner class file is dispatched into the corresponding associated code resource bundle, so that respective anonymous inner classes can be bundled into correct code resource modules. The technical solutions of the embodiments of the present disclosure solve the problem of no dispatching after the anonymous inner classes are uniformly bundled into the base code resource bundle, and can process the anonymous inner class files generated after desugaring to correctly dispatch the anonymous inner class files into the corresponding resource bundles, so as to optimize the base code resource bundle of the application program.

### BRIEF DESCRIPTION OF THE DRAWINGS

The above and other features, advantages, and aspects of the respective embodiments of the present disclosure will become more apparent by combining the accompanying drawings and referring to the following specific implementations. Throughout the accompanying drawings, identical or similar reference numerals represent identical or similar elements. It should be understood that the accompanying drawings are illustrative, and components and elements may not necessarily be drawn to scale.

FIG. 1 is a flowchart of a class file processing method provided according to an embodiment of the present disclosure;

FIG. 2 is a flowchart of a class file processing method provided according to an embodiment of the present disclosure;

FIG. 3 is a flowchart of bundling an application program into an AAB file provided according to an embodiment of the present disclosure;

FIG. 4 is a flowchart of a class file processing method provided according to an embodiment of the present disclosure;

FIG. 5 is a flowchart of packaging an application program into an AAB file provided according to an embodiment of the present disclosure;

FIG. 6 is a schematic structural diagram of a class file processing apparatus provided according to an embodiment of the present disclosure; and

FIG. 7 is a schematic structural diagram of an electronic device provided according to an embodiment of the present disclosure.

### DETAILED DESCRIPTION OF EMBODIMENTS

The embodiments of the present disclosure will be described in detail below with reference to the accompanying drawings. Although the accompanying drawings show some embodiments of the present disclosure, it should be understood that the present disclosure can be implemented in various forms, and should not be explained as being limited to the embodiments stated herein. Rather, these embodiments are provided for understanding the present disclosure more thoroughly and completely. It should be understood that the accompanying drawings and embodiments of the present disclosure are only used for illustration, but are not intended to limit the protection scope of the present disclosure.

It should be understood that respective steps recorded in method implementations of the present disclosure can be executed in different orders and/or in parallel. In addition, the method implementations may include additional steps and/or omit the execution of the steps shown. The scope of the present disclosure is not limited in this aspect.

The term “include” and its variants as used herein mean widespread inclusion, namely, “including but not limited to”. The term “based on” is “based at least in part on”. The term “one embodiment” means “at least one embodiment”. The term “another embodiment” means “at least another embodiment”. The term “some embodiments” means “at least some embodiments”. Relevant definitions of other terms will be given in the description below.

It should be noted that the concepts such as “first” and “second” mentioned in the present disclosure are only used to distinguish different apparatuses, modules, or units, and are not intended to limit the order or interdependence of the functions performed by these apparatuses, modules, or units.

It should be noted that the modifications of “one” and “plurality” mentioned in the present disclosure are indicative rather than restrictive, and those skilled in the art should understand that unless otherwise explicitly stated in the context, they should be understood as “one or more”.

It can be understood that before use of the technical solutions disclosed in various embodiments of the present disclosure, users should be informed of the type, scope of use, usage scenarios, and the like of personal information involved in the present disclosure in accordance with relevant laws and regulations in an appropriate manner, so as to obtain authorization from the users.

For example, in response to that an active request of a user has been received, prompt information is sent to the user to clearly remind the user that personal information of the user needs to be involved in an operation requested to be executed. Thus, the user can independently select whether to provide the personal information to software or hardware such as an electronic device, an application program, a server, or a storage medium that performs the operation of the technical solutions of the present disclosure according to the prompt information.

As an optional but non-restrictive implementation, in response to that an active request of a user has been received, prompt information is sent to the user through, for example, a pop-up window where the prompt information can be presented in text. In addition, the pop-up window can also carry a selection control for the user to select whether to “agree” or “refuse” to provide the personal information to the electronic device.

It can be understood that the above notification and the above user authorization obtaining process are only illustrative and do not constitute a limitation on the implementations of the present disclosure. Other methods that meet the relevant laws and regulations can also be applied to the implementations of the present disclosure.

It can be understood that data involved in the technical solutions (including but not limited to the data itself, and obtaining or use of the data) should comply with the requirements of corresponding laws and regulations and relevant provisions.

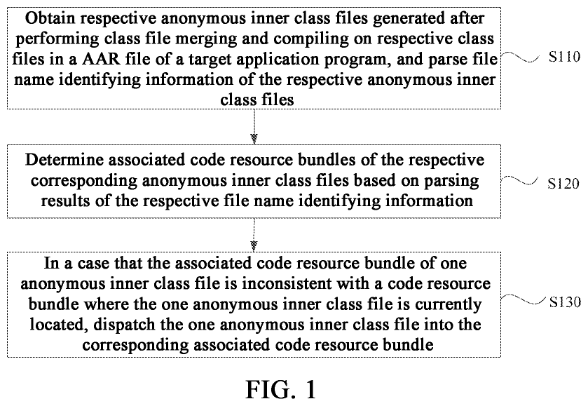

FIG. 1 is a flowchart of a class file processing method provided according to an embodiment of the present disclosure. This embodiment of the present disclosure is applicable to a scenario of bundling an application program into an AAB format, especially in a situation of processing anonymous inner class files generated in the bundling process. The method can be executed by a class file processing apparatus. The apparatus can be implemented in the form of software and/or hardware. Optionally, the apparatus can be implemented through an electronic device, The electronic device can be a mobile terminal, a personal computer (PC) end, a server, or the like.

As shown in FIG. 1, the class file processing method includes:

S110. Respective anonymous inner class files generated after performing class file merging and compiling on respective class files in an AAR file of a target application program are obtained, and file name identifying information of the respective anonymous inner class files is parsed.

The target application program can be any application program that needs to be bundled and posted. By correctly dispatching code resource files of the target application, the code resource files are finally compiled and bundled to generate an application program bundle that meets a format requirement of a target application program posting platform. In this embodiment, the processing of the class files is performed in a process of bundling the AAR file of the target application program into an AAB posting format.

The code resource files of the target application program can be the class files in the AAR file on which the corresponding target application program depends. AAR is a binary archive file of an Android library project with a filename extension of .aar, which includes the class files and resource files such as values, layout, and manifest in Android.

In the process of bundling and generating the target application bundle based on the AAR file, different Android versions support different Java Virtual Machine (Jvm). When a high-version Java Development Kit (jdk) syntax that is not supported by a current Android version is used, the jdk syntax needs to be converted into a low-version jdk syntax that can be supported by the current Android version during the compiling of the AAR file. This process is referred to as desugaring. Usually, the desugaring may be performed when a DexBuilder (dexbuilder/D8) compiles the class files in the AAR file. In this process, some anonymous inner class files may be generated. An anonymous inner class is an anonymous subclass object with a specific implementation parent class or parent interface, which can make a code more concise. However, all the generated anonymous inner classes may be directly bundled into a base code resource bundle, without further sub-bundling. In this case, some anonymous inner class files generated by an adaptive function code resource bundle are finally bundled into the base code resource bundle, so that the base code resource bundle may contain some unnecessary class files.

In this embodiment, in order to achieve correct distribution and bundling of the anonymous inner class files to optimize the content of the base code resource bundle, the anonymous inner class files are dispatched especially after the code resource files are compiled to generate the anonymous inner class files.

Specifically, for the compiled class files, the anonymous inner class files can be identified based on symbols in file name identifying information. Then, the file name identifying information of each anonymous inner class file is analyzed to determine sub-bundling attributions of the respective anonymous inner class files. The file name identifying information refers to a class file name of each of the anonymous inner class files determined according to a preset naming rule. In the preset naming rule, each part of the file name identifying information represents its corresponding meaning, so that target information can be found by analyzing the file name identifying information for subsequent file sub-bundling. The target information can be identifying information that identifies the class as an anonymous inner class, and an information content such as information of an associated code resource bundle.

S120. Associated code resource bundles of the respective corresponding anonymous inner class files are determined based on parsing results of the file name identifying information.

The parsing results can be target information extracted from the file name identifying information of the respective anonymous inner class files according to the preset naming rule for class file names. Information of the corresponding associated code resource bundles can be determined based on the extracted target information, thereby determining that a file source of the corresponding anonymous inner class file is a base code resource bundle or any adaptive function code resource bundle.

Exemplarily, the name of a class file is: com/aabb/bundle/df/-$$Lambda$DfMainActivity$5wDgUb-EcYaG0CrNwjbhy_zCN_w. By analyzing the file name identifying information, “-$$Lambda$” represents that the class file is an anonymous inner class file, and it can be determined that an original class file corresponding to the anonymous inner class is com/aabb/bundle/df/DfMainActivity. Where “df” (dynamic feature) represents that the anonymous inner class file is a class file generated by the code resources in the adaptive function code resource bundle and should be dispatched to the corresponding adaptive feature code resource bundle for bundling.

S130. In response to that the associated code resource bundle of one anonymous inner class file is inconsistent with a code resource bundle where the one anonymous inner class file is currently located, the one anonymous inner class file is dispatched into the corresponding associated code resource bundle.

Since all the anonymous inner class files are dispatched by default into the base code resource bundle for bundling, in this embodiment, when the associated code resource bundle of one anonymous inner class file is inconsistent with the code resource bundle where the one anonymous inner class file is currently located, the one anonymous inner class file may be dispatched into the corresponding associated code resource bundle. That is, if the associated code resource bundle of an anonymous inner class file is a certain adaptive function code resource bundle, the anonymous inner class file is deleted from the base code resource bundle into the corresponding adaptive function code resource bundle. This can avoid that a class file that does not need to be bundled into the base code resource bundle is bundled into the Base bundle. Therefore, after the above steps are executed, a file volume of the base code resource bundle in the AAB of the target application program obtained through the subsequent bundling operation is further reduced, which is beneficial for downloading and use by a user.

In the technical solutions of the embodiments of the present disclosure, in a process of generating an application program bundle with an AAB format, respective anonymous inner class files generated after performing class file merging and compiling on respective class files in an AAR file of a target application program are sub-bundled; file name identifying information of the respective anonymous inner class files are first parsed; associated code resource bundles of the respective corresponding anonymous inner class files are determined based on parsing results of the file name identifying information; and in response to that the associated code resource bundle of one anonymous inner class file is inconsistent with a code resource bundle where the one anonymous inner class file is currently located, the one anonymous inner class file is dispatched into the corresponding associated code resource bundle, so that respective anonymous inner classes can be bundled into correct code resource modules. The technical solutions of the embodiments of the present disclosure solve the problem of no dispatching after the anonymous inner classes are uniformly bundled into the base code resource bundle, and can process the anonymous inner class files generated after desugaring to correctly dispatch the anonymous inner class files into the corresponding resource bundles, so as to optimize the base code resource bundle of the application program.

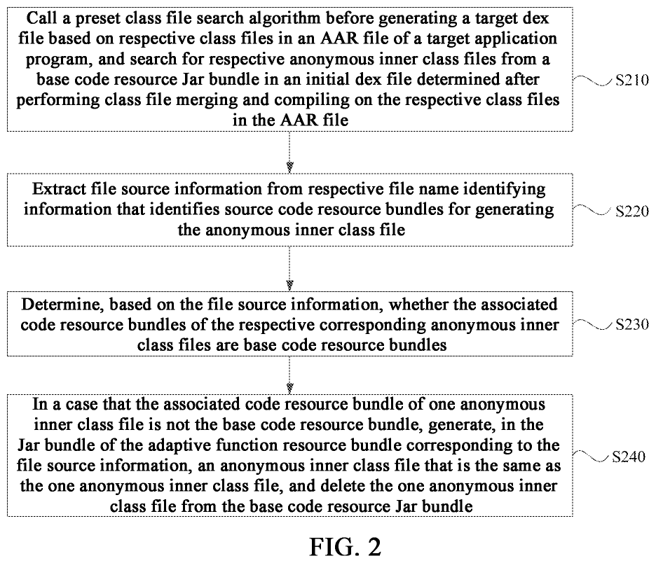

FIG. 2 is a flowchart of a class file processing method provided according to an embodiment of the present disclosure. This embodiment of the present disclosure is applicable to a scenario of bundling an application program into a posting format, namely Android App Bundle (AAB), and further describes a specific process of implementing sub-bundling processing on anonymous inner class files. The method can be executed by a class file processing apparatus. The apparatus can be implemented in the form of software and/or hardware. Optionally, the apparatus can be implemented through an electronic device, the electronic device can be a mobile terminal, a PC end, a server, or the like.

As shown in FIG. 2, the class file processing method includes:

S210. A preset class file search algorithm is called before a target dex file is generated based on respective class files in an AAR file of a target application program, and respective anonymous inner class files are searched for from a base code resource Jar bundle in an initial dex file determined after performing class file merging and compiling on the respective class files in the AAR file.

A process of generating a target dex file is a process of reconfiguring and integrating class files in Base Jar in a base code resource bundle in a code resource file and class files in Dynamic Feature Jar in an adaptive function resource bundle, and all classes in the respective generated target dex files can be shared.

The initial dex file refers to a dex file in an initial state that has not yet undergone specific class file attribution division when a class file attribution division function (splitDex) is executed. When splitDex is executed, the preset class file search algorithm is first called. The algorithm can be called using a hook function. Then, the respective anonymous inner class files are searched for from the base code resource Jar bundle based on the preset class file search algorithm.

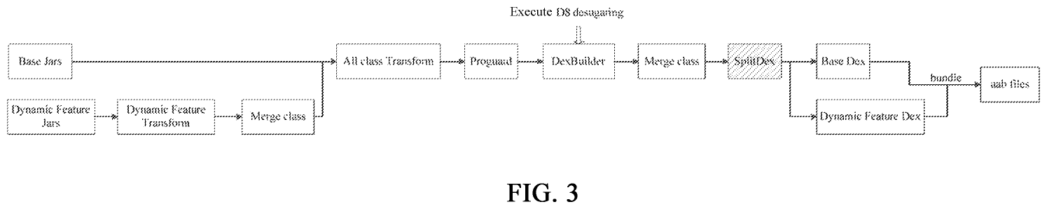

The specific timing for calling the preset class file search algorithm can refer to the flowchart of an AAB generation process shown in FIG. 3, that is, after D8 performs desugaring, the anonymous inner class files are searched for at the splitDex node. Whether the class file is an anonymous inner class file is determined by analyzing whether the file name identifying information of each class file contains “-$$Lambda$”.

S220. File source information that identifies source code resource bundles for generating the anonymous inner class files are extracted from the file name identifying information of the respective anonymous inner class files according to a preset class file naming format.

The parsing results can be file source information extracted from the file name identifying information of the respective anonymous inner class files according to the preset naming rule for class file names. Information of corresponding associated code resource bundles can be determined based on the extracted file source information, thereby determining whether a file source of the corresponding anonymous inner class file is a base code resource bundle or any adaptive function code resource bundle.

S230. Whether the associated code resource bundles of the respective corresponding anonymous inner class files are base code resource bundles is determined based on the file source information.

S240. In response to that the associated code resource bundle of one anonymous inner class file is not the base code resource bundle, an anonymous inner class file that is the same as the one anonymous inner class file is generated in the Jar bundle of the adaptive function resource bundle corresponding to the file source information, and the one anonymous inner class file is deleted from the base code resource Jar bundle.

The anonymous inner class file that is the same as the one anonymous inner class file is generated in the Jar bundle of the adaptive function resource bundle corresponding to the file source information, that is, the same anonymous inner class file can be generated through a preset bytecode compiler.

Through the movement of the anonymous inner class file, the base code resource Jar bundle and the Jar bundle of the corresponding adaptive function resource bundle in the initial dex file are updated, so that the target dex file can be generated subsequently after the anonymous inner class files are correctly dispatched.

In the technical solutions of the embodiments of the present disclosure, in a process of generating an application program bundle with an AAB format, when splitDex is executed, respective anonymous inner class files generated after performing class file merging and compiling on respective class files in an AAR file of a target application program are first sub-bundled; file name identifying information of the respective anonymous inner class files are parsed; associated code resource bundles of the respective corresponding anonymous inner class files are determined based on parsing results of the file name identifying information; and in response to that the associated code resource bundle of one anonymous inner class file is inconsistent with a code resource bundle where the one anonymous inner class file is currently located, the one anonymous inner class file is dispatched into the corresponding associated code resource bundle, so that respective anonymous inner classes can be bundled into correct code resource modules. The technical solutions of the embodiments of the present disclosure solve the problem of no dispatching after the anonymous inner classes are uniformly bundled into the base code resource bundle, and can process the anonymous inner class files generated after desugaring to correctly dispatch the anonymous inner class files into the corresponding resource bundles, so as to optimize the base code resource bundle of the application program.

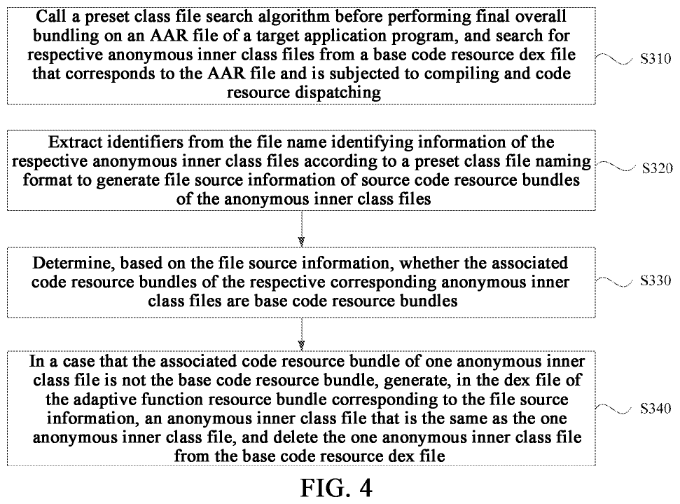

FIG. 4 is a flowchart of a class file processing method provided according to an embodiment of the present disclosure. This embodiment of the present disclosure is applicable to a scenario of bundling an application program into a posting format, namely AAB, and further describes an optional implementation of sub-bundling anonymous inner class files. The method can be executed by a class file processing apparatus. The apparatus can be implemented in the form of software and/or hardware. Optionally, the apparatus can be implemented through an electronic device. The electronic device can be a mobile terminal, a PC end, a server, or the like.

As shown in FIG. 4, the class file processing method includes:

S310. A preset class file search algorithm is called before final overall bundling is performed on an AAR file of a target application program, and respective anonymous inner class files are searched for from a base code resource dex file that corresponds to the AAR file and is subjected to compiling and code resource dispatching.

The final overall bundling can be understood as a process of compiling and bundling target dex files (including base dex and dynamic feature dex) to generate a final AAB (aab files).

In this embodiment, in order to solve the problem that the anonymous inner class files are not correctly dispatched into the correct code resource bundles, before the final overall bundling, the preset class file search algorithm may be called to search for the respective anonymous inner class files from the base code resource dex file (base dex) that corresponds to the AAR file of the target application program and is subjected to compiling and code resource dispatching. It is possible to determine whether the class file is an anonymous inner class file by analyzing whether the file name identifying information of each class file contains “-$$Lambda$”.

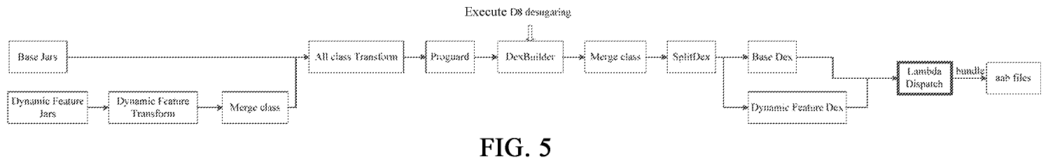

The execution timing of this step can refer to node “Lambda Dispatch” (anonymous inner class file dispatching) in an AAB bundling process shown in FIG. 5, which means adding a process node before “bundling” is performed on base dex and dynamic feature dex.

S320. File source information that identifies source code resource bundles for generating the anonymous inner class files is extracted from the respective file name identifying information according to a preset class file naming format.

The parsing results can be file source information extracted from the file name identifying information of the respective anonymous inner class files according to the preset naming rule for class file names. Information of corresponding associated code resource bundles can be determined based on the extracted file source information, thereby determining that a file source of the corresponding anonymous inner class file is a base code resource bundle or any adaptive function code resource bundle.

S330. Whether the associated code resource bundles of the respective corresponding anonymous inner class files are base code resource bundles is determined based on the file source information.

S340. In response to that the associated code resource bundle of one anonymous inner class file is not the base code resource bundle, an anonymous inner class file that is the same as the one anonymous inner class file is generated in the dex file of the adaptive function resource bundle corresponding to the file source information, and the one anonymous inner class file is deleted from the base code resource dex file.

In this step, after the anonymous inner class files are adjusted, contents of the class files in base dex and dynamic feature dex generated based on splitDex are updated. Subsequently, the final bundling can be performed according to the updated dex files to generate the AAB (aab files) of the target application program.

In the technical solutions of the embodiments of the present disclosure, before the last bundling step of generating an application program bundle with an AAB format, respective anonymous inner class files generated in the dex files after performing class file merging and compiling on respective class files in an AAR file of a target application program are sub-bundled; file name identifying information of the respective anonymous inner class files are first parsed; associated code resource bundles of the respective corresponding anonymous inner class files are determined based on parsing results of the file name identifying information; and when the associated code resource bundle of one anonymous inner class file is inconsistent with a code resource bundle where the one anonymous inner class file is currently located, the one anonymous inner class file is dispatched to the corresponding associated code resource bundle, so that respective anonymous inner classes can be bundled into correct code resource modules. The technical solutions of the embodiments of the present disclosure solve the problem of no dispatching after the anonymous inner classes are uniformly bundled into the base code resource bundle, and can process the anonymous inner class files generated after desugaring to correctly dispatch the anonymous inner class files into the corresponding resource bundles, so as to optimize the base code resource bundle of the application program.

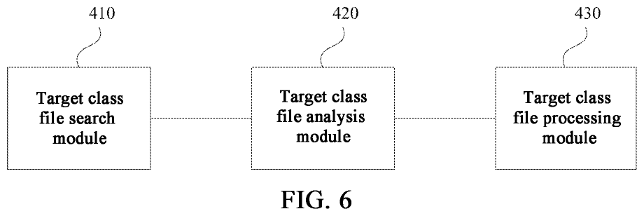

FIG. 6 is a schematic structural diagram of a class file processing apparatus provided according to an embodiment of the present disclosure. The apparatus is applicable to a scenario of bundling an application program into an AAB format, especially in a situation of processing anonymous inner class files generated in the bundling process. The class file processing apparatus can be implemented in the form of software and/or hardware and can be configured in an electronic device. The electronic device can be a mobile terminal, a PC end, a server, or the like.

As shown in FIG. 6, the class file processing apparatus includes: a target class file search module 410, a target class file analysis module 420, and a target class file processing module 430.

The target class file searching module 410 is configured to: obtain respective anonymous inner class files generated after performing class file merging and compiling on respective class files in an AAR file of a target application program, and parse file name identifying information of the respective anonymous inner class files; the target class file analysis module 420 is configured to determine associated code resource bundles of the respective corresponding anonymous inner class files based on parsing results of the file name identifying information; and the target class file processing module 430 is configured to: in response to that the associated code resource bundle of one anonymous inner class file is inconsistent with a code resource bundle where the one anonymous inner class file is currently located, dispatch the one anonymous inner class file into the corresponding associated code resource bundle.

In the technical solutions of the embodiments of the present disclosure, in a process of generating an application program bundle with an AAB format, respective anonymous inner class files generated after performing class file merging and compiling on respective class files in an AAR file of a target application program are sub-bundled; file name identifying information of the respective anonymous inner class files are first parsed; associated code resource bundles of the respective corresponding anonymous inner class files are determined based on parsing results of the file name identifying information; and in response to that the associated code resource bundle of one anonymous inner class file is inconsistent with a code resource bundle where the one anonymous inner class file is currently located, the one anonymous inner class file is dispatched into the corresponding associated code resource bundle, so that respective anonymous inner classes can be bundled into correct code resource modules. The technical solutions of the embodiments of the present disclosure solve the problem of no dispatching after the anonymous inner classes are uniformly bundled into the base code resource bundle, and can process the anonymous inner class files generated after desugaring to correctly dispatch the anonymous inner class files into the corresponding resource bundles, so as to optimize the base code resource bundle of the application program.

Based on any optional technical solution in the embodiments of the present disclosure, the target class file search module 410 is specifically configured to:

extract, according to a preset class file naming format, file source information from respective file name identifying information that identifies source code resource bundles for generating the anonymous inner class files.

Based on any optional technical solution in the embodiments of the present disclosure, the target class file analysis module 420 is specifically configured to:

for each of the anonymous inner class files, determine, according to the file source information, whether a file source of the corresponding anonymous inner class file is a base code resource bundle or any adaptive function code resource bundle.

Based on any optional technical solution in the embodiments of the present disclosure, the target class file search module 410 can be further specifically configured to:

call a preset class file search algorithm before generating a target dex file; and

search, based on the preset class file search algorithm, for the respective anonymous inner class files from a base code resource Jar bundle in an initial dex file determined after performing the class file merging and compiling on the respective class files in the AAR file.

Based on the above optional technical solutions in the embodiments of the present disclosure, the target class file processing module 430 can be specifically configured to:

generate, in the corresponding adaptive function Jar bundle, an anonymous inner class file that is the same as the one anonymous inner class file, and delete the one anonymous inner class file from the base code resource Jar bundle.

Based on any optional technical solution in the embodiments of the present disclosure, the target class file search module 410 can be further specifically configured to:

call a preset class file search algorithm before performing final overall bundling on the AAR file of the target application program; and

search for the respective anonymous inner class files based on the preset class file search algorithm from a base code resource dex file that corresponds to the AAR file and is subjected to compiling and code resource dispatching.

Based on the above optional technical solutions in the embodiments of the present disclosure, the target class file processing module 430 can be specifically configured to:

generate, in a corresponding adaptive function dex file, an anonymous inner class file that is the same as the one anonymous inner class file, and delete the one anonymous inner class file from the base code resource dex file.

The above class file processing apparatus provided according to the embodiments of the present disclosure can implement the class file processing method provided in any embodiment of the present disclosure, and has corresponding functional modules for implementing the method and corresponding beneficial effects.

It is worth noting that the respective units and modules included in the above apparatus are only divided according to a functional logic, but are not limited to the above division, as long as the corresponding functions can be achieved. In addition, the specific names of the respective functional units are only for the purpose of distinguishing and are not used to limit the protection scope of the embodiments of the present disclosure.

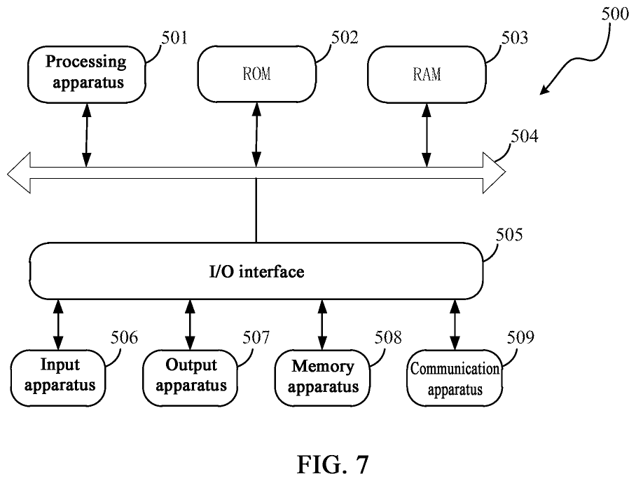

FIG. 7 is a schematic structural diagram of an electronic device according to the embodiments of the present disclosure. Reference is now made to FIG. 7 below, which illustrates a schematic structural diagram of an electronic device (namely, a terminal device or a server in FIG. 7) 500 suitable for implementing the embodiments of the present disclosure. The terminal device in the embodiments of the present disclosure may include, but is not limited to, a mobile phone, a laptop, a digital broadcast receiver, a Personal Digital Assistant (PDA), a Portable Android Device (PAD), a Portable Media Player (PMP), a mobile terminal such as a vehicle-mounted terminal (for example, a vehicle-mounted navigation terminal), and a fixed terminal such as digital television (TV) and a desktop computer. The electronic device shown in FIG. 7 is only an example and should not impose any limitations on the functionality and scope of use of the embodiments of the present disclosure.

As shown in FIG. 7, the electronic device 500 may include a processing apparatus (such as a central processing unit and graphics processor) 501 that can perform various appropriate actions and processing according to programs stored in a Read-Only Memory (ROM) 502 or loaded from a memory apparatus 508 to a Random Access Memory (RAM) 503. Various programs and data required for operations of the electronic device 500 may also be stored in the RAM 503. The processing apparatus 501, the ROM 502, and the RAM 503 are connected to each other through a bus 504. An Input/Output (I/O) interface 505 is also connected to the bus 504.

Usually, following apparatuses can be connected to the I/O interface 505: an input apparatus 506 including a touch screen, a touchpad, a keyboard, a mouse, a camera, a microphone, an accelerometer, a gyroscope, and the like; an output apparatus 507 including a Liquid Crystal Display (LCD), a speaker, a vibrator, and the like; a memory apparatus 508 including a magnetic tape, a hard disk drive, and the like; and a communication apparatus 509. The communication apparatus 509 can allow the electronic device 500 to wirelessly or wiredly communicate with other devices to exchange data. Although FIG. 7 shows the electronic device 500 with multiple apparatuses, it should be understood that the electronic device 500 is not required to implement or have all the apparatuses shown, and can alternatively implement or have more or fewer apparatuses.

Particularly, according to the embodiments of the present disclosure, the process described in the reference flowchart above can be implemented as a computer software program. For example, the embodiments of the present disclosure include a computer program product, including a computer program carried on a non-transitory computer-readable medium, and the computer program includes program codes used for performing the methods shown in the flowcharts. In such an embodiment, the computer program may be downloaded and installed from a network through the communication apparatus 509, or installed from the memory apparatus 508, or installed from the ROM 502. When the computer program is executed by the processing apparatus 501, the above-mentioned functions defined in the methods of the embodiments of the present disclosure are executed.

Messages or names of information exchanged between a plurality of apparatuses in the implementations of the present disclosure are only for illustrative purposes and are not intended to limit the messages or the scope of the information.

The electronic device provided according to the embodiments of the present disclosure and the class file processing method provided in the above embodiments belong to the same invention concept. Technical details not fully described in this embodiment can be found in the above embodiments, and this embodiment has the same beneficial effects as the above embodiments.

The embodiments of the present disclosure provide a computer storage medium, storing a computer program. The program, when executed by a processor, implements the class file processing method provided by the above embodiments.

It should be noted that the computer-readable medium mentioned in the present disclosure can be a computer-readable signal medium, a computer-readable storage medium, or any combination of the computer-readable signal medium and the computer-readable storage medium. The computer-readable storage medium can be, for example, but not limited to, electric, magnetic, optical, electromagnetic, infrared, or semiconductor systems, apparatuses, or devices, or any combination of the above. More specific examples of the computer-readable storage medium may include, but are not limited to: an electrical connection with one or more wires, a portable computer disk, a hard disk drive, a RAM, a ROM, an Erasable Programmable Read Only Memory (EPROM) or flash memory, an optical fiber, a Compact Disc Read-Only Memory (CD-ROM), an optical storage device, a magnetic storage device, or any suitable combination of the above. In the present disclosure, the computer-readable storage medium may be any tangible medium that contains or stores a program, and the program can be used by or in combination with an instruction execution system, apparatus, or device. In the present disclosure, the computer-readable signal media may include data signals propagated in a baseband or as part of a carrier wave, which carries computer-readable program codes. The propagated data signals can be in various forms, including but not limited to: electromagnetic signals, optical signals, or any suitable combination of the above. The computer-readable signal medium may also be any computer-readable medium other than a computer-readable storage medium. The computer-readable signal medium can send, propagate, or transmit programs for use by or in combination with an instruction execution system, apparatus, or device. The program codes contained in the computer-readable medium can be transmitted using any suitable medium, including but are not limited to: a wire, an optical cable, a Radio Frequency (RF), and the like, or any suitable combination of the above.

In some implementations, clients and servers can communicate using any currently known or future developed network protocol such as a HyperText Transfer Protocol (HTTP), and can intercommunicate and be interconnected with digital data in any form or medium (for example, a communication network). Examples of the communication network include a Local Area Network (LAN), a Wide Area Network (WAN), an internet (such as an Internet), a point-to-point network (such as an ad hoc point-to-point network, and any currently known or future developed network.

The computer-readable medium may be included in the electronic device or exist alone and is not assembled into the electronic device.

The above computer-readable medium carries one or more programs. When executed by the electronic device, the one or more programs cause the electronic device to:

obtain respective anonymous inner class files generated after performing class file merging and compiling on respective class files in an Android Archive (AAR) file of a target application program, and parse file name identifying information of the respective anonymous inner class files;

determine associated code resource bundles of the respective corresponding anonymous inner class files based on parsing results of the file name identifying information; and

in response to the associated code resource bundle of one anonymous inner class file is inconsistent with a code resource bundle where the one anonymous inner class file is currently located, dispatch the one anonymous inner class file into the corresponding associated code resource bundle.

Computer program codes for performing the operations of the present disclosure may be written in one or more programming languages or a combination thereof. The above programming languages include but are not limited to an object-oriented programming language such as Java, Smalltalk, and C++, and conventional procedural programming languages such as “C” language or similar programming languages. The program codes may be executed entirely on a user computer, partly on a user computer, as a stand-alone software package, partly on a user computer and partly on a remote computer, or entirely on a remote computer or a server. In response to that a remote computer is involved, the remote computer can be connected to a user computer through any kind of networks, including a LAN or a WAN, or can be connected to an external computer (for example, through an Internet using an Internet service provider).

The flowcharts and block diagrams in the accompanying drawings illustrate possible system architectures, functions, and operations that may be implemented by a system, a method, and a computer program product according to respective embodiments of the present disclosure. In this regard, each block in a flowchart or a block diagram may represent a module, a program, or a part of a code. The module, the program, or the part of the code includes one or more executable instructions used for implementing specified logic functions. In some implementations used as substitutes, functions annotated in blocks may alternatively occur in a sequence different from that annotated in an accompanying drawing. For example, actually two blocks shown in succession may be performed basically in parallel, and sometimes the two blocks may be performed in a reverse sequence. This is determined by a related function. It is also be noted that each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

The units described in the embodiments of the present disclosure can be implemented through software or hardware. The name of the unit does not constitute a limitation on the unit itself. For example, the first obtaining unit can also be described as “a unit that obtains at least two Internet protocol addresses”.

The functions described herein above may be performed, at least in part, by one or a plurality of hardware logic components. For example, nonrestrictively, example hardware logic components that can be used include: a Field Programmable Gate Array (FPGA), an Application Specific Integrated Circuit (ASIC), Application Specific Standard Parts (ASSP), a System on Chip (SOC), a Complex Programmable Logic Device (CPLD), and the like.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable medium may include an electrical connection based on one or more wires, a portable computer disk, a hard disk drive, a RAM, a ROM, an EPROM or flash memory, an optical fiber, a CD-ROM, an optical storage device, a magnetic storage device, or any suitable combinations of the above contents.

The embodiments of the present disclosure further provide a computer program product, including a computer program, and the computer program, when executed by a processor, implements the class file processing method provided in any of the embodiments of the present disclosure.

In the implementation process of the computer program product, computer program codes for performing the operations of the present disclosure may be written in one or more programming languages or a combination thereof. The programming languages include an object-oriented programming language such as Java, Smalltalk, and C++, and conventional procedural programming languages such as “C” language or similar programming languages. The program codes may be executed entirely on a user computer, partly on a user computer, as a stand-alone software package, partly on a user computer and partly on a remote computer, or entirely on a remote computer or a server. In response to that a remote computer is involved, the remote computer can be connected to a user computer through any kind of networks, including a LAN or a WAN, or can be connected to an external computer (for example, through an Internet using an Internet service provider).

According to one or more embodiments of the present disclosure, Example I provides a class file processing method. The method includes:

obtaining respective anonymous inner class files generated after performing class file merging and compiling on respective class files in an Android Archive (AAR) file of a target application program, and parsing file name identifying information of the respective anonymous inner class files;

determining associated code resource bundles of the respective corresponding anonymous inner class files based on parsing results of the file name identifying information; and

in response to that the associated code resource bundle of one anonymous inner class file is inconsistent with a code resource bundle where the one anonymous inner class file is currently located, dispatching the one anonymous inner class file ito the corresponding associated code resource bundle.

According to one or more embodiments of the present disclosure, Example II provides a class file processing method, further including:

In some optional implementations, the parsing file name identifying information of the respective anonymous inner class files includes:

extracting, according to a preset class file naming format, file source information from respective file name identifying information that identifies source code resource bundles for generating the anonymous inner class files.

According to one or more embodiments of the present disclosure, Example III provides a class file processing method, including:

In some optional implementations, the determining associated code resource bundles of the respective corresponding anonymous inner class files based on parsing results of the respective file name identifying information includes:

for each of the anonymous inner class files, determining, according to the file source information, that a file source of the corresponding anonymous inner class file is a base code resource bundle or any adaptive function code resource bundle.

According to one or more embodiments of the present disclosure, Example IV provides a class file processing method, further including:

In some optional implementations, the obtaining respective anonymous inner class files generated after performing class file merging and compiling on respective class files in an AAR file of a target application program includes:

calling a preset class file search algorithm before generating a target dex file; and

searching, based on the preset class file search algorithm, for the respective anonymous inner class files from a base code resource Jar bundle in an initial dex file determined after performing the class file merging and compiling on the respective class files in the AAR file.

According to one or more embodiments of the present disclosure, Example V provides a class file processing method, further including:

In an optional implementation, the dispatching the one anonymous inner class file to the corresponding associated code resource bundle includes:

generating, in the corresponding adaptive function Jar bundle, an anonymous inner class file that is the same as the one anonymous inner class file, and deleting the one anonymous inner class file from the base code resource Jar bundle.

According to one or more embodiments of the present disclosure, Example VI provides a class file processing method, further including:

In some optional implementations, the obtaining respective anonymous inner class files generated after performing class file merging and compiling on respective class files in an AAR file of a target application program includes:

calling a preset class file search algorithm before performing final overall bundling on the AAR file of the target application program; and

searching for the respective anonymous inner class files based on the preset class file search algorithm from a base code resource dex file that corresponds to the AAR file and is subjected to compiling and code resource dispatching.

According to one or more embodiments of the present disclosure, Example VII provides a class file processing method, further including:

In an optional implementation, the dispatching the one anonymous inner class file to the corresponding associated code resource bundle includes:

generating, in a corresponding adaptive function dex file, an anonymous inner class file that is the same as the one anonymous inner class file, and deleting the one anonymous inner class file from the base code resource dex file.

According to one or more embodiments of the present disclosure, Example VIII provides a class file processing apparatus, including:

a target class file searching module, configured to: obtain respective anonymous inner class files generated after performing class file merging and compiling on respective class files in an AAR file of a target application program, and parse file name identifying information of the respective anonymous inner class files;

a target class file analysis module, configured to determine associated code resource bundles of the respective corresponding anonymous inner class files based on parsing results of the file name identifying information; and

a target class file processing module, configured to: in response to that the associated code resource bundle of one anonymous inner class file is inconsistent with a code resource bundle where the one anonymous inner class file is currently located, dispatch the one anonymous inner class file into the corresponding associated code resource bundle.

According to one or more embodiments of the present disclosure, Example IX provides a class file processing apparatus, further including:

In an optional implementation, the target class file search module is specifically configured to:

extract, according to a preset class file naming format, file source information from respective file name identifying information that identifies source code resource bundles for generating the anonymous inner class files.

According to one or more embodiments of the present disclosure, Example X provides a class file processing apparatus, further including:

In an optional implementation, the target class file analysis module is specifically configured to:

for each of the anonymous inner class files, determine, according to the file source information, that a file source of the corresponding anonymous inner class file is a base code resource bundle or any adaptive function code resource bundle.

According to one or more embodiments of the present disclosure, Example XI provides a class file processing apparatus, further including:

In an optional implementation, the target class file search module can be further specifically configured to:

call a preset class file search algorithm before generating a target dex file; and

search for the respective anonymous inner class files based on the preset class file search algorithm from a base code resource Jar bundle in an initial dex file determined after performing the class file merging and compiling on the respective class files in the AAR file.

According to one or more embodiments of the present disclosure, Example XII provides a class file processing apparatus, further including:

In an optional implementation, the target class file processing module can be specifically configured to:

generate, in the corresponding adaptive function Jar bundle, an anonymous inner class file that is the same as the one anonymous inner class file, and delete the one anonymous inner class file from the base code resource Jar bundle.

According to one or more embodiments of the present disclosure, Example XIII provides a class file processing apparatus, further including:

In an optional implementation, the target class file search module can be further specifically configured to:

call a preset class file search algorithm before performing final overall bundling on the AAR file of the target application program; and

search, based on the preset class file search algorithm, for the respective anonymous inner class files from a base code resource dex file that corresponds to the AAR file and is subjected to compiling and code resource dispatching.

According to one or more embodiments of the present disclosure, Example XIV provides a class file processing apparatus, further including:

In an optional implementation, the target class file processing module can be specifically configured to:

generate, in a corresponding adaptive function dex file, an anonymous inner class file that is the same as the one anonymous inner class file, and delete the one anonymous inner class file from the base code resource dex file.

The above description is only for explaining the preferred embodiments of the present disclosure and technical principles used in the embodiments. Those skilled in the art should understand that the scope of disclosure referred to in the present disclosure is not limited to the technical solutions formed by specific combinations of the aforementioned technical features, but also covers other technical solutions formed by any combinations of the aforementioned technical features or their equivalent features without departing from the concept of the above disclosure, for example, a technical solution formed by replacing the above features with (but not limited to) technical features with similar functions disclosed in the present disclosure.

In addition, although various operations are depicted in a specific order, this should not be understood as requiring these operations to be executed in the specific order shown or in a sequential order. In certain environments, multitasking and parallel processing may be advantageous. Similarly, although several specific implementation details are included in the above discussion, these should not be interpreted as limiting the scope of the present disclosure. Some features described in the context of individual embodiments can also be combined and implemented in a single embodiment. On the contrary, various features that are described in the context of the single embodiment may also be implemented in a plurality of embodiments separately or in any suitable sub-combinations.

Although the subject matter has been described in a language specific to structural features and/or method logical actions, it should be understood that the subject matter limited in the attached claims may not necessarily be limited to the specific features or actions described above. On the contrary, the specific features and actions described above are only exemplary forms for implementing the claims.

I/We claim:

1. A class file processing method, comprising:
obtaining respective anonymous inner class files generated after performing class file merging and compiling on respective class files in an Android Archive (AAR) file of a target application program, and parsing file name identifying information of the respective anonymous inner class files;
determining associated code resource bundles of respective corresponding anonymous inner class files based on parsing results of respective file name identifying information; and
in response to that the associated code resource bundle of one anonymous inner class file is inconsistent with a code resource bundle where the one anonymous inner class file is currently located, dispatching the one anonymous inner class file into corresponding associated code resource bundle.

2. The method according to claim 1, wherein parsing the file name identifying information of the respective anonymous inner class files comprises:
extracting, according to a preset class file naming format, file source information from respective file name identifying information that identifies source code resource bundles for generating the anonymous inner class files.

3. The method according to claim 2, wherein determining the associated code resource bundles of the respective corresponding anonymous inner class files based on the parsing results of the respective file name identifying information comprises:
determining, according to respective file source information, whether a file source of a corresponding anonymous inner class file is a base code resource bundle or any adaptive function code resource bundle for the respective anonymous inner class files.

4. The method according to claim 1, wherein obtaining the respective anonymous inner class files generated after performing class file merging and compiling on the respective class files in the AAR file of the target application program comprises:
calling a preset class file search algorithm before generating a target dex file; and
searching, based on the preset class file search algorithm, for respective anonymous inner class files from a base code resource Jar bundle in an initial dex file determined after performing class file merging and compiling on respective class files in the AAR file.

5. The method according to claim 4, wherein dispatching the one anonymous inner class file into the corresponding associated code resource bundle comprises:
generating, in a corresponding adaptive function Jar bundle, an anonymous inner class file that is the same as the one anonymous inner class file, and deleting the one anonymous inner class file from the base code resource Jar bundle.

6. The method according to claim 1, wherein obtaining the respective anonymous inner class files generated after performing class file merging and compiling on the respective class files in the AAR file of the target application program comprises:
calling a preset class file search algorithm before performing final overall bundling on an AAR file of a target application program; and
searching for respective anonymous inner class files based on the preset class file search algorithm from a base code resource dex file that corresponds to the AAR file and is subjected to compiling and code resource dispatching.

7. The method according to claim 6, wherein dispatching the one anonymous inner class file into the corresponding associated code resource bundle comprises:
generating, in a corresponding adaptive function dex file, an anonymous inner class file that is the same as the one anonymous inner class file, and deleting the one anonymous inner class file from the base code resource dex file.

8. An electronic device, comprising:
one or more processors;
a storage for storing one or more programs which, when executed by the one or more processors, cause the one or more processors to:
obtain respective anonymous inner class files generated after performing class file merging and compiling on respective class files in an Android Archive (AAR) file of a target application program, and parsing file name identifying information of the respective anonymous inner class files;
determine associated code resource bundles of respective corresponding anonymous inner class files based on parsing results of respective file name identifying information; and
in response to that the associated code resource bundle of one anonymous inner class file is inconsistent with a code resource bundle where the one anonymous inner class file is currently located, dispatch the one anonymous inner class file into corresponding associated code resource bundle

9. The electronic device according to claim 8, wherein the one or more programs which causes the one or more processors to parse the file name identifying information of the respective anonymous inner class files further causes the one or more processors to:
extract, according to a preset class file naming format, file source information from respective file name identifying information that identifies source code resource bundles for generating the anonymous inner class files.

10. The electronic device according to claim 9, wherein the one or more programs which causes the one or more processors to determine the associated code resource bundles of the respective corresponding anonymous inner class files based on the parsing results of the respective file name identifying information further causes the one or more processors to:
determine, according to respective file source information, whether a file source of a corresponding anonymous inner class file is a base code resource bundle or any adaptive function code resource bundle for the respective anonymous inner class files.

11. The electronic device according to claim 8, wherein the one or more programs which causes the one or more processors to obtain the respective anonymous inner class files generated after performing class file merging and compiling on the respective class files in the AAR file of the target application program further causes the one or more processors to:
call a preset class file search algorithm before generating a target dex file; and
search, based on the preset class file search algorithm, for respective anonymous inner class files from a base code resource Jar bundle in an initial dex file determined after performing class file merging and compiling on respective class files in the AAR file.

12. The electronic device according to claim 11, wherein the one or more programs which causes the one or more processors to dispatch the one anonymous inner class file into the corresponding associated code resource bundle further causes the one or more processors to:
generate, in a corresponding adaptive function Jar bundle, an anonymous inner class file that is the same as the one anonymous inner class file, and deleting the one anonymous inner class file from the base code resource Jar bundle.

13. The electronic device according to claim 8, wherein the one or more programs which causes the one or more processors to obtain the respective anonymous inner class files generated after performing class file merging and compiling on the respective class files in the AAR file of the target application program further causes the one or more processors to:
call a preset class file search algorithm before performing final overall bundling on an AAR file of a target application program; and
search for respective anonymous inner class files based on the preset class file search algorithm from a base code resource dex file that corresponds to the AAR file and is subjected to compiling and code resource dispatching.

14. The electronic device according to claim 13, wherein the one or more programs which causes the one or more processors to dispatch the one anonymous inner class file into the corresponding associated code resource bundle further causes the one or more processors to:
generate, in a corresponding adaptive function dex file, an anonymous inner class file that is the same as the one anonymous inner class file, and deleting the one anonymous inner class file from the base code resource dex file.

15. A computer program product being tangibly stored on a computer-readable medium and comprising a computer program, wherein the computer program, when executed by a processor, causes the processor to:
obtain respective anonymous inner class files generated after performing class file merging and compiling on respective class files in an Android Archive (AAR) file of a target application program, and parsing file name identifying information of the respective anonymous inner class files;
determine associated code resource bundles of respective corresponding anonymous inner class files based on parsing results of respective file name identifying information; and
in response to that the associated code resource bundle of one anonymous inner class file is inconsistent with a code resource bundle where the one anonymous inner class file is currently located, dispatch the one anonymous inner class file into corresponding associated code resource bundle

16. The computer program product according to claim 15, wherein the computer program which causes the processor to parse the file name identifying information of the respective anonymous inner class files further causes the processor to:
extract, according to a preset class file naming format, file source information from respective file name identifying information that identifies source code resource bundles for generating the anonymous inner class files.

17. The computer program product according to claim 16, wherein the computer program which causes the processor to determine the associated code resource bundles of the respective corresponding anonymous inner class files based on the parsing results of the respective file name identifying information further causes the processor to:
determine, according to respective file source information, whether a file source of a corresponding anonymous inner class file is a base code resource bundle or any adaptive function code resource bundle for the respective anonymous inner class files.

18. The computer program product according to claim 15, wherein the computer program which causes the processor to obtain the respective anonymous inner class files generated after performing class file merging and compiling on the respective class files in the AAR file of the target application program further causes the processor to:
call a preset class file search algorithm before generating a target dex file; and
search, based on the preset class file search algorithm, for respective anonymous inner class files from a base code resource Jar bundle in an initial dex file determined after performing class file merging and compiling on respective class files in the AAR file.

19. The computer program product according to claim 18, wherein the computer program which causes the processor to dispatch the one anonymous inner class file into the corresponding associated code resource bundle further causes the processor to:
generate, in a corresponding adaptive function Jar bundle, an anonymous inner class file that is the same as the one anonymous inner class file, and deleting the one anonymous inner class file from the base code resource Jar bundle.

20. The computer program product according to claim 15, wherein the computer program which causes the processor to obtain the respective anonymous inner class files generated after performing class file merging and compiling on the respective class files in the AAR file of the target application program further causes the processor to:
call a preset class file search algorithm before performing final overall bundling on an AAR file of a target application program; and
search for respective anonymous inner class files based on the preset class file search algorithm from a base code resource dex file that corresponds to the AAR file and is subjected to compiling and code resource dispatching.
